(19) United States
(12) Patent Application Publication
(10) Pub. No.: US 2025/0117662 A1
(43) Pub. Date: Apr. 10, 2025

(54) METHOD FOR DETERMINING SIMILARITY RELATIONS BETWEEN TABLES

(71) Applicant: One Data GmbH, Passau (DE)

(72) Inventors: Christian BACHMAIER, Passau (DE); Andreas BÖHM, Passau (DE); Stefan RAMESEDER, Passau (DE); Sebastian WERNICKE, Passau (DE)

(21) Appl. No.: 18/730,051

(22) PCT Filed: Jan. 19, 2023
(86) PCT No.: PCT/EP2023/051176

§ 371 Date: Jul. 18, 2024

(30) Foreign Application Priority Data
Jan. 20, 2022 (EP) 22152350.9

(51) Int. Cl. G06N 3/088; G06F 16/22

(52) U.S. Cl. CPC G06N 3/088; G06F 16/2282

(57) ABSTRACT

The invention relates to a computer-implemented method for determining similarity relations between various tables by means of machine-learning computing modules.

### FIELD

The present disclosure relates to a computer-implemented method for determining similarity relations between tables or data sources containing tables.

### BACKGROUND

In particular in companies there are often a large number of different data sources in which information is stored in relational data formats, in particular tables. The data sources can originate e.g. from different business processes or different parts of the company, for example from a PLM system (PLM: Product Lifecycle Management), a CRM system (CRM: Customer Relationship Management), an ERP system (ERP: Enterprise Resource Planning), etc.

In complex data collections having different data sources, it is difficult to recognize what information actually exists, how the overall data is structured, what relationships exist between the individual data sources and how data from different data sources can be linked together to create complex data correlations.

### SUMMARY

On this basis, an object of the present disclosure is to provide a method which makes it possible to determine similarities between information from different data sources and in this way make the data easier to understand for a human user.

A method and computer program which contains a program code for carrying out the method for determining similarity relations between different are disclosed herein.

According to a first aspect, the present disclosure relates to a computer-implemented method for determining similarity relations between different tables. The method comprises the following steps:

First, a plurality of different tables is received. The tables contain information arranged in a structured manner in rows and columns. In other words, relational data is thus available.

The information in the tables is then processed and abstracted column by column. The column-by-column processing and abstracting results in column-related metadata that characterizes the information contained in a column of the respective table. In other words, the column-related metadata is information which is derived from the information in the columns and provides additional data to the column information. The metadata can be basic metadata or complex metadata, for example. Basic metadata can be, for example, column names, data type of the values contained in the column, number of different values in the column, number of zero values in the column, smallest column value, largest column values, etc. The complex metadata can, for example, include information that is determined from the basic metadata by calculation or analysis. The complex metadata can be, for example, minimum length of the column values, maximum length of the column values, minimum number of letters in the column values, maximum number of letters in the column values, minimum number of digits in the column values, maximum number of digits in the column values, average ratio of digits and numbers in the column values, etc.

A plurality of machine-learning computing modules is provided. At least some of the machine-learning computing modules are pre-trained computing modules and/or at least some of the machine-learning computing modules must first be trained by means of the table information. Some of the machine-learning computing modules are trained, for example, in that some of the column-related metadata is supplied to at least some of the machine-learning computing modules in order to train them on patterns contained in the column-related metadata.

The column-related metadata, in particular all column-related metadata, is then supplied to the trained computing modules. The individual computing modules each determine at least one pattern indicator for the columns of a table. The pattern indicator is a parameter for the presence of a pattern in the respective column of a table. The pattern indicator can, for example, indicate whether the respective column contains information that is similar, for example, to an email address, account connecting details or a telephone number etc.

A plurality of pattern indicators, which were generated by different trained computing modules and each relate to the same column of the respective table, are then aggregated. This means that a plurality of pattern indicators is collected that originate from different computing modules. These multiple column-related pattern indicators are combined, as a result of which combination pattern indicators are formed, each of which is assigned to a column of a table. Thereby so-called model averaging is achieved, which compensates for overfitting or underfitting of individual models.

The combination pattern indicators of various tables are compared with one another in order to establish similarity relations between at least some of the columns of the tables. By comparing individual combination pattern indicators, it is possible to determine whether individual columns have a similarity relation or how high the degree of similarity is. By comparing the combination pattern indicators determined for the respective columns of a table, it is possible to determine the overall similarity of the individual tables.

Finally, at least one similarity value is calculated on the basis of the comparison of the combination pattern indicators, which value characterizes the similarity between columns of different tables. Alternatively or additionally, at least one similarity value is calculated on the basis of the comparison of the combination pattern indicators, which value characterizes the similarity between different tables that contain multiple columns.

The technical advantage of the method is that the machine-learning computing modules render possible an overview of data structures that are stored in a distributed manner, which makes the existing relationships recognizable and the data does not have to be merged in a common database but can remain in their respective storage locations. The machine-learning computing modules also make it possible to automatically and adaptively recognize data correlations and thus identify the relationship between the individual pieces of data.

According to one exemplary embodiment, the length of a character string, the data type of the information, the value range of the information, the ratio of letters and numbers, an indicator regarding the similarity of the values of the column and/or the frequency of the presence of special characters is determined by processing and abstracting the information column by column. This column-related metadata makes it possible to determine data correlations that cannot be adequately determined from the raw data itself.

According to one exemplary embodiment, the machine-learning computing modules are trained with a part of the column-related metadata during training by means of an unsupervised learning process (so-called unsupervised machine learning). This makes it possible to train the computing modules without prior so-called labeling of the training data.

According to one exemplary embodiment, the training of the machine-learning computing modules is carried out in multiple steps, a subset of the entire column-related metadata being used as training data in each of the training steps and at least partially different training data is used in successive training steps by changing the subset of the entire column-related metadata. This allows the computing modules to be trained in an improved manner on the overall column-related metadata.

According to one exemplary embodiment, at least some of the machine-learning computing modules have a different structure. For example, the machine-learning computing modules can have a different number of layers (e.g. layers of a neural network) and/or a different number of neurons (also referred to as “features”) in the respective layers. This makes it possible for the machine-learning computing modules to be able to recognize various patterns in the tables or the metadata thereof.

According to one exemplary embodiment, at least some of the machine-learning computing modules are neural networks. Neural networks can be advantageously trained to recognize patterns in character strings. Alternatively, other structures that render possible machine learning can also be used in the computing modules, for example ensemble models with random forest or boosted trees.

According to one exemplary embodiment, the degree of agreement between the combination pattern indicators is checked when comparing the combination pattern indicators of different columns. For example, the combination pattern indicator is a numerical value. By comparing the numerical values, it is possible to determine the degree of similarity between columns in different tables.

According to one exemplary embodiment, semantic table properties are determined on the basis of column designations, table designations and/or one or more comments associated with the table. The semantic table properties can indicate the content of a table. Conclusions can be drawn from the semantic table properties as to which data is stored in the table. This information can then be used to determine similarity relations between the tables.

According to one exemplary embodiment, the similarity value, which characterizes the similarity between columns of different tables or the similarity between different tables, is determined on the basis of the semantic table properties. So, the semantic table properties are used in addition to the pattern indicators determined by the machine-learning computing modules to determine the similarity of tables or the columns thereof.

According to one exemplary embodiment, the pre-trained machine-learning computing modules have been pre-trained on the basis of training data that is different from the column-related metadata of the received tables and contains predetermined patterns. The pre-trained machine-learning computing modules are preferably designed to recognize defined patterns such as email addresses or account connecting details. These computing modules can be advantageously trained by data containing defined patterns of this type and can then be used as pre-trained computing modules in the method to recognize the patterns for which they have been pre-trained. This allows globally or regionally standardized patterns in the data to be recognized in an improved manner.

According to one exemplary embodiment, after calculating the at least one similarity value, the machine-learning computing modules are retrained by evaluating the calculated similarity value and generating evaluation information. The machine-learning computing modules can be adjusted on the basis of the evaluation information. Alternatively or additionally, the algorithm for forming combination pattern indicators can be adjusted. This makes it possible to retrain the machine-learning computing modules on the basis of the recognized similarity relations, i.e. to adjust the weights of the neural network, for example, in such a way that the recognition of similarity relations is improved. On the basis of the evaluation information, it is also possible to adjust the weighting of the individual pattern indicators when calculating the combination pattern indicators in such a way that the calculated similarity value better reflects the actually existing similarity of the columns.

According to one exemplary embodiment, the pattern indicators are weighted differently when forming combination pattern indicators. This allows the results of certain computing modules to be weighted more than the results of the other computing modules. In particular, the weighting can be adaptively adjusted, for example on the basis of semantic table information that provides an indication that certain computing modules will provide a more accurate result than others (e.g. computing modules trained on account data for the data of a column with the column name “account number”).

According to one exemplary embodiment, a graphical output that represents the similarity relations of the overall tables and the columns of the individual tables is generated on the basis of the tables and the similarity relations of the tables. The representation can, for example, be a map-like representation that captures the data available in an organization, such as a company, and places it in a context-dependent relationship to one another. The map-like representation can, for example, have multiple layers by means of which the data can be represented at different levels of abstraction. This can make it easier for the human user to understand the data available in an organization.

According to one exemplary embodiment, the column-related metadata, the pattern indicators and the resulting combination pattern indicators are redetermined when the information contained in the tables is changed and, on this basis, the similarity value which characterizes the similarity between columns of different tables and/or the similarity between different tables, is recalculated. This allows the similarity relations between columns of various tables or similarity relations between different tables to be adjusted iteratively, for example when the table data is changed or new tables are created.

The expressions “approximately”, “substantially” or “about” in the sense of the present disclosure mean deviations from the respectively exact value by +/−10%, preferably by +/−5% and/or deviations in the form of changes that are insignificant for the function.

Further embodiments, advantages and possible applications of the present disclosure are also apparent from the following description of exemplary embodiments and from the drawings. All the features described and/or illustrated, either individually or in any combination, are in principle the subject matter of the present disclosure, irrespective of their summary in the claims or their relationship to one another. The content of the claims is also made part of the description.

### BRIEF DESCRIPTION OF THE DRAWINGS

The present disclosure is explained in more detail below by means of a plurality of drawings on the basis of exemplary embodiments, wherein:

FIG. 1 shows, exemplarily and schematically, an example of a data structure with multiple data sources;

FIG. 2 shows, by way of example, multiple tables with different data, the tables being linked to one another by information relationships;

FIG. 3 shows, exemplarily and schematically, a system for determining similarity relations between a plurality of tables;

FIG. 4 shows, by way of example, a map-like representation of similarity relations between different data sources in a company in a first layer;

FIG. 5 shows, by way of example, a map-like representation of similarity relations between different data sources in a company in a second layer; and

FIG. 6 shows, by way of example, a flowchart illustrating the steps of a method for determining similarity relations between different tables.

### DETAILED DESCRIPTION

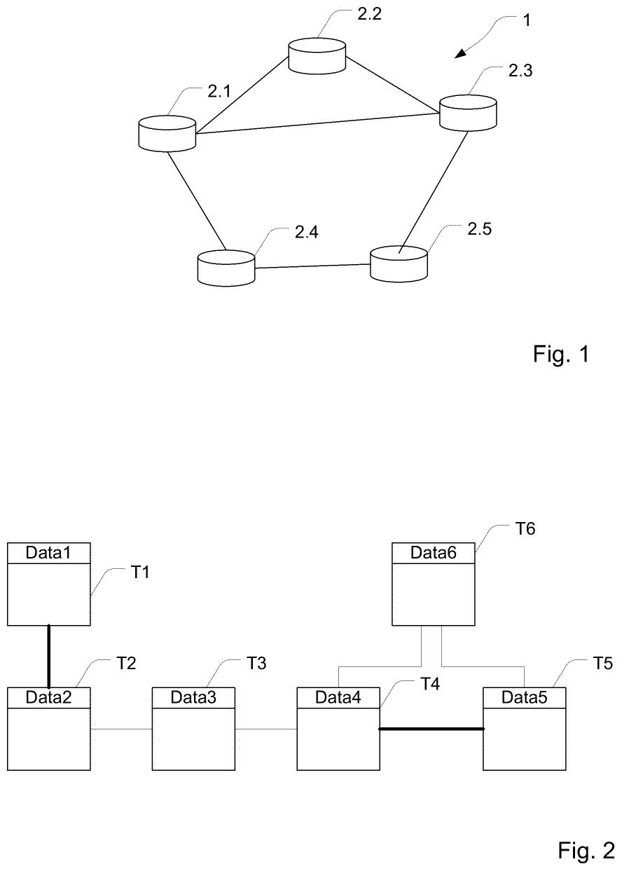

FIG. 1 shows, by way of example, a data storage arrangement 1 in a company comprising a plurality of data sources 2.1 to 2.5. The data sources 2.1 to 2.5 are e.g. databases in which the information is stored in relational data formats, i.e. in the form of tables. As indicated by the lines, the data sources 2.1 to 2.5 are connected to one another in order to exchange information with one another.

FIG. 2 shows, exemplarily and schematically, a plurality of tables T1-T6, the contents of which are labeled “Data1” to “Data6” by way of example. The lines between tables T1-T6 indicate that information relationships exist between the individual tables. As indicated by the different line thicknesses, the information relationships between tables T1-T6 can be of different types. Tables T1-T6 can be assigned basic information that characterizes the information contained in the respective table. The basic information of the table can, for example, be its title, table description and/or column designations in the table. For example, tables T2 and T3 can both refer to orders placed by customers, it being known from the table title or a table description for table T2, for example, that table T2 refers e.g. to basic order information and table T3 to detailed information on the orders. This basic information of tables T2 and T3 already shows that tables T2 and T3 are related to one another (indicated by a thin connecting line).

Tables T1 and T2, on the other hand, are not assigned any basic information that indicates that there is a relationship between the tables. For example, table T1 refers to data logging and table T2 to detailed information on orders. The basic information of tables T1 and T2 (e.g. title, table description, etc.) does not disclose that these tables are related to one another and, for example, that individual columns of the tables have a high degree of correspondence (indicated by the bold connecting line between tables T1 and T2).

The same applies, mutatis mutandis, e.g. to tables T4 and T5, both of which have no information relationships on the basis of basic information, but rather information relationships that are not directly recognizable and are recognizable by means of machine-learning algorithms.

The similarity relation of tables T1 to T6 as a whole or the similarity relation of at least individual columns of the tables can be determined by means of the method described in more detail below, which uses machine-learning computing modules.

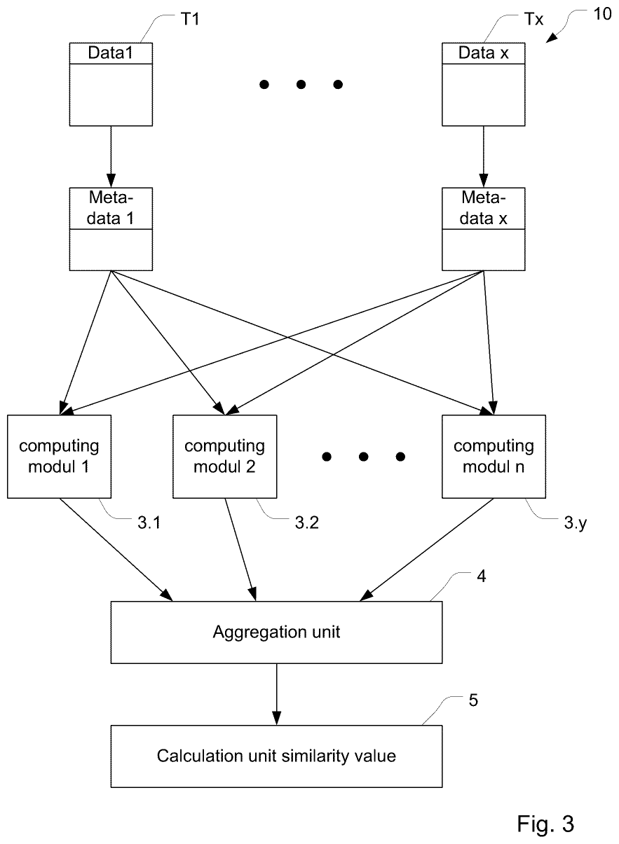

FIG. 3 shows a schematic diagram which illustrates the functional units of a system 10 for determining similarity relations between different tables.

First, tables T1 to Tx (where x is a natural number) are analyzed and metadata is generated for the individual columns of these tables. The metadata can include basic metadata and/or complex metadata. The basic metadata is, for example, information that can be determined directly from a column of the table, such as column names, data type of the values contained in the column (string, numbers, integer values, floating point values, etc.), number of different values in the column, number of zero values in the column, smallest column value, largest column value, etc. The complex metadata can, for example, comprise information that is determined from the basic metadata by calculation or analysis. The complex metadata can be, for example: minimum length of the column values, maximum length of the column values, minimum number of letters in the column values, maximum number of letters in the column values, minimum number of digits in the column values, maximum number of digits in the column values, average ratio of digits and numbers in the column values, etc.

Furthermore, the generation of metadata can also include the determination of basic information. This basic information can relate either to the individual columns of the tables and/or to the respective table as a whole. The basic information can, for example, comprise semantic information, i.e. information that indicates the meaning of linguistic characters and character strings in the table. The basic information can, for example, contain information on the table name, on the column names and/or on comments or table descriptions. For example, the basic information can specify which column titles the columns of a table have, how often a certain word occurs in the column titles, etc.

Preferably, the determined metadata itself is stored in a database, namely such that it is assigned to the table, the metadata of which it comprises.

As can be seen in FIG. 3, the system 10 has a plurality of machine-learning computing modules 3.1-3.y. The machine-learning computing modules 3.1-3.y can, for example, be artificial neural networks. Alternatively, other types of machine-learning computing modules can also be used, at least in part, for example ensemble models with random forest or boosted trees.

The machine-learning computing modules 3.1-3.y are designed or configured differently. For example, the machine-learning computing modules 3.1-3.y can have a different architecture, i.e. e.g. a different number of layers and/or a different number of neurons in the respective layers. This ensures that the machine-learning computing modules 3.1-3.y generate different output information for the same input information due to the different structure. For example, one machine-learning computing module can provide better recognition of characteristic letter-number sequences while another machine-learning computing module can provide better recognition of email addresses.

The machine-learning computing modules 3.1-3.y must be trained in advance to recognize characteristic patterns (also referred to as patterns) in the metadata of tables T1 to Tx.

The training of the machine-learning computing modules 3.1-3.y can be carried out in different ways.

At least some of the machine-learning computing modules 3.1-3.y can be trained, for example, by supplying the machine-learning computing modules 3.1-3.y with part of the metadata of tables T1 to Tx and training the machine-learning computing modules 3.1-3.y on the basis of this part of the metadata. The training can be carried out using an unsupervised learning process, for example. During the unsupervised learning process, the machine-learning computing module attempts to recognize patterns in the input data that deviate from the structureless noise and to adjust the weights of the machine-learning computing module in such a way that these recognized patterns are better captured by the machine-learning computing module.

Alternatively, the training can also take place by means of a supervised learning process in which a pattern recognition is checked by a person and the result of the check is supplied to the learning process as training feedback.

In addition, the machine-learning computing modules 3.1-3.y can be at least partially pre-trained modules, i.e. can be pre-trained to recognize certain patterns (e.g. Bank Identifier Code (BIC), International Bank Account Number (IBAN), email addresses, etc.) independently of the currently received metadata, and as such pre-trained computing modules can be used in the system 10 without further training.

After receiving the metadata for the respective tables T1 to Tx, the trained machine-learning computing modules 3.1-3.y generate pattern indicators. The pattern indicators are column-related pattern indicators, i.e. the pattern indicators indicate a probability that a certain pattern is contained in the column to which the pattern indicator refers. For example, a pattern indicator that indicates the presence of a “zip code” can have a high value if the length of the column data is five digits each and the column data only consists of numbers.

The computing modules 3.1-3.y determine at least one pattern indicator for each of the columns in tables T1 to Tx. The pattern indicator is here a parameter for the presence of a pattern in the respective column of a table. For example, a pattern indicator can indicate how similar the column entries are to a certain pattern type, such as zip code, IBAN, email address, etc.

The pattern indicators provided by the computing modules 3.1-3.y are then transmitted to an aggregation unit 4 of the system 10. The aggregation unit 4 is designed to aggregate and combine the pattern indicators provided by the computing modules 3.1-3.y. In this context, “aggregate” means that a plurality of results of the computing modules are combined in order to recognize correlations between the individual results. Combination pattern indicators are formed by combining the aggregated pattern indicators. Combining the aggregated pattern indicators can comprise, for example, the formation of average values. This results in so-called “model averaging”, i.e. an average value is determined from the results of different models, which can have different levels of quality in recognizing the respective patterns. The average value forms the combination pattern indicator and is assigned to a column of a table. This allows so-called overfitting/overestimation or underfitting/underestimation of individual computing modules 3.1-3.y to be compensated for.

When combining multiple pattern indicators to form at least one combination pattern indicator, the pattern indicators can be weighted differently. For example, a first pattern indicator can be given a higher weight than a second pattern indicator in order to increase the influence of the higher weighted pattern indicator on the combination pattern indicator compared to the lower weighted pattern indicator.

The weighting of the pattern indicators can be determined in different ways. For example, the weighting of the pattern indicators can be based on a defined set of rules, the set of rules specifying how a pattern indicator provided by a first computing module influences the weighting of a pattern indicator provided by a second computing module. For example, a pattern indicator of a first computing module that has a value above a threshold value can be a strong indication that a certain pattern type is present for which the first computing module is trained (e.g. email). The set of rules can contain a rule that if the pattern indicator of the first computing module exceeds the threshold value, the pattern indicator of a second computing module is given an increased weighting, for example a computing module trained for text recognition, whereas a pattern indicator of a third computing module is underweighted or completely neglected (i.e. weighting factor of 0), for example a computing module trained for telephone numbers or IBAN.

Furthermore, the weighting of the pattern indicators for calculating the combination pattern indicators can be determined by means of a monitored machine-learning algorithm. In this way, the weighting of the individual pattern indicators determined by the algorithm can be checked and adjusted by an evaluating person when calculating the combination pattern indicators so that the similarity relations expressed by the combination pattern indicators correspond more closely to the actually existing similarity relations. These adjusted weightings can be used to train the supervised machine-learning algorithm that is used to calculate the weightings of the pattern indicators. In this way, the supervised machine-learning algorithm can be successively improved in such a way that the weighting of the pattern indicators that is calculated by the algorithm increasingly corresponds to the weighting determined by the evaluating person.

In addition, the weighting can also be influenced by evaluating semantic table information. For example, a column name can provide information about what content can be found in this table. For example, the column name “email” is an indication that email addresses can be found in this column. In this case, the weighting of a computing module that is specifically trained to recognize email patterns can be overweighted compared to another computing module that is trained, for example, to recognize numerical sequences.

The combination pattern indicators calculated by aggregation unit 4 are then supplied to a calculation unit 5. The calculation unit 5 is designed to determine similarity relations between at least parts of multiple tables by comparing the combination pattern indicators of columns of these tables. After comparing the combination pattern indicators, the calculation unit 5 determines a similarity value on the basis of the combination pattern indicators. This similarity value indicates the degree of similarity between columns of different tables, the similarity between column groups of different tables and/or the similarity between different overall tables. The similarity value is therefore a measure of the similarity of tables or parts of tables, which can be used to graphically illustrate the similarities and thus make them easier for the human user to understand.

In addition to the metadata used for training, the machine-learning computing modules 3.1-3.y can receive further information that is used as training data. For example, the basic information (e.g. semantic information such as table names, column names, comments and/or table descriptions) can be used to train the models. This makes it possible to adjust the computing modules 3.1-3.y to the formats, contexts and/or content used in the data in an improved way.

In addition, the machine-learning computing modules 3.1-3.y can be trained on the basis of standardized data formats (email, IBAN, BIC) in order to better recognize these data formats. The term “standardized data formats” refers to data formats that are standardized in a general and user-independent manner, as well as user-specific standardized data formats, i.e. data formats that occur multiple times in different data sources in data sets of a specific user.

On the basis of the trained machine-learning computing modules 3.1-3.y, it is possible to examine the data present in the different data sources 2.1-2.5 with regard to similarity relations. For example, it is possible to determine other columns in the data for a given column that have similar content and therefore form a partner column with sufficient similarity. In addition, columns from other data sets with similar information content can be determined for each column of a data set. In this way, similarity relations between the different data sources 2.1-2.5 can be determined and graphically visualized.

In order to be able to react to changes in the data stored in the data sources 2.1-2.5 and their relationships to one another, the method is preferably carried out iteratively.

In the iteration steps, it is e.g. possible, on the basis of the existing, trained, machine-learning computing modules 3.1-3.y, to analyze again the data stored in the data sources and to determine column-related pattern indicators. Updated combination pattern indicators can be determined from these recalculated, column-related pattern indicators of the individual computing modules 3.1-3.y.

By comparing the updated combination pattern indicators, updated similarity values can be calculated that indicate the similarity relations of columns, parts of tables or entire tables.

The machine-learning computing modules 3.1-3.y can also be retrained in the iteration steps if the change in the data makes this necessary.

In order to determine the temporal change in the data or the temporal change in the similarity of the data, the temporal change in the similarity values can be logged so that the chronology of the data change can be traced at a later point in time.

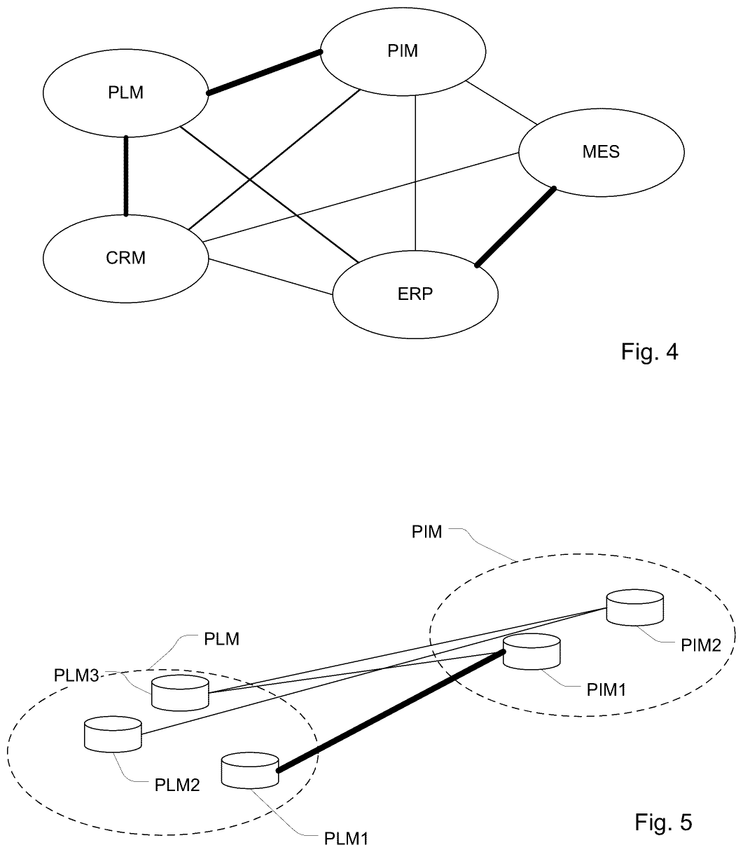

FIG. 4 shows, by way of example, a representation of a visual illustration of similarity relations between data in different data sources 2.1-2.5. The illustration is provided by means of an interactive map, which is structured similarly to a cartographic map and has multiple levels of abstraction. By selecting abstraction levels, the user can adjust the information density and change the granularity of the data.

As shown in FIG. 4, for example, the data sources of individual software modules such as ERP (Enterprise Resource Planning), PLM (Product Lifecycle Management), CRM (Customer Relationship Management), PIM (Product Information Management) and MES (Machine Execution System) can be displayed at the top level. The line thicknesses between the individual data sources indicate, for example, the overall similarity of the data between the individual data sources.

FIG. 5 shows, by way of example, the similarity relations between the PIM and PLM data sources at an abstraction level that is one level lower. The line thicknesses between the individual data sources again indicate the similarity of the data. This shows that the strong similarity of the data sources PIM and PLM is mainly due to the high similarity of the sub-data sources PIM1 with PLM1 and that the other sub-data sources only have low similarities.

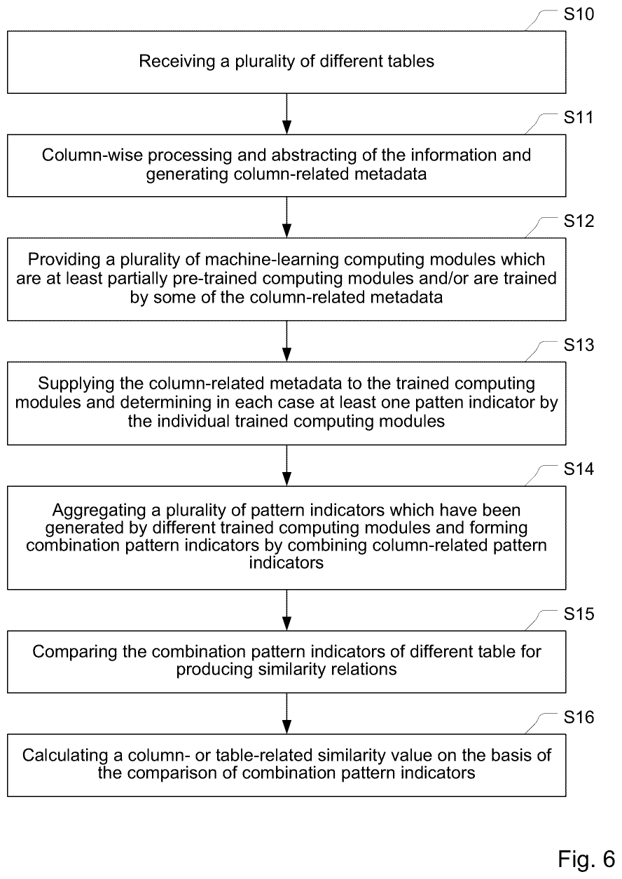

FIG. 6 shows a block diagram that illustrates the steps of the method for determining similarity relations between different tables.

First, multiple different tables are received. The tables contain information that is arranged in a structured manner in rows and columns (S10).

The information is then processed and abstracted column by column. By processing and abstracting column by column, column-related metadata is determined that characterizes the information contained in a column of the respective table (S11).

In addition, a plurality of machine-learning computing modules is provided. At least some of the machine-learning computing modules are pre-trained computing modules and/or at least some of the machine-learning computing modules are trained by supplying some of the column-related metadata to at least some of the machine-learning computing modules in order to train them on patterns contained in the column-related metadata so as to obtain trained computing modules (S12).

The column-related metadata is supplied to the trained computing modules, the individual computing modules determining in each case at least one pattern indicator on the basis of the column-related metadata for the columns of a table, which pattern indicator is indicative for the presence of a pattern in the respective column of a table (S13).

Subsequently, a plurality of pattern indicators, which were generated by different trained computing modules and each refer to the same column of the respective table, is aggregated and combined so as to form combination pattern indicators which are each assigned to a column of a table (S14).

Thereafter, the combination pattern indicators of different tables are compared in order to establish similarity relations between at least some of the columns of the tables (S15).

Finally, at least one similarity value is calculated on the basis of the comparison of the combination pattern indicators, which value characterizes the similarity between columns of different tables and/or at least one similarity value is calculated which characterizes the similarity between different tables containing multiple columns (S16).

The present disclosure has been described above by means of exemplary embodiments. It is understood that numerous changes and modifications are possible without departing from the scope of protection defined by the claims.

### LIST OF REFERENCE SIGNS

1 arrangement for data storage
2.1-2.5 data sources
3.1-3.y computing module
4 aggregation unit
5 calculation unit
10 system
T1-T6 table

1. Computer-implemented method for determining similarity relations between different tables on the basis of a system including a plurality of machine-learning computing modules, an aggregation unit and a calculation unit, the method comprising the following steps:
receiving a plurality of different tables, wherein the tables contain information arranged in a structured manner in rows and columns;
processing and abstracting the information column by column, wherein the column-by-column processing and abstracting determines column-related metadata which characterizes the information contained in a column of the respective table;
providing a plurality of machine-learning computing modules, wherein the machine-learning computing modules are designed differently, namely in such a way that, due to the different structure, the machine-learning computing modules generate different output information for the same input information, wherein at least some of the machine-learning computing modules are pre-trained computing modules and/or at least some of the machine-learning computing modules are trained in that some of the column-related metadata is supplied to at least some of the machine-learning computing modules in order to train them on patterns contained in the column-related metadata so as to obtain trained computing modules;
supplying the column-related metadata to the trained computing modules, wherein the individual computing modules each determine at least one pattern indicator for the columns of a table, which pattern indicator is indicative for the presence of a pattern in the respective column of a table;
aggregating, by means of the aggregation unit, a plurality of pattern indicators which were generated by different trained computing modules and each relate to the same column of the respective table, and combining these column-related pattern indicators, thereby forming combination pattern indicators which are each assigned to a column of a table;
comparing the combination pattern indicators of different tables in order to establish similarity relations between at least some of the columns of the tables;
calculating, by means of the calculation unit, at least one similarity value which characterizes the similarity between columns of different tables and/or calculating at least one similarity value which characterizes the similarity between different tables containing a plurality of columns on the basis of the comparison of the combination pattern indicators.

2. The method according to claim 1, wherein the length of a character string, the data type of the information, the value range of the information, the ratio of letters and numbers, an indicator relating to the similarity of the values of the column and/or the frequency of the presence of special characters is determined by processing and abstracting the information column by column.

3. The method according to claim 1 wherein, during training, the machine-learning computing modules are trained with a part of the column-related metadata by an unsupervised learning process.

4. The method according to claim 1 wherein the training of the machine-learning computing modules is carried out in a plurality of steps, wherein in each of the training steps a subset of the entire column-related metadata is used as training data and in each of successive training steps at least partially different training data is used by changing the subset of the entire column-related metadata.

5. The method according to claim 1 wherein the machine-learning computing modules are at least partially neural networks.

6. The method according to claim 1 wherein, when comparing the combination pattern indicators of different columns, it is checked how high the degree of agreement of the combination pattern indicators is.

7. The method according to claim 1 wherein semantic table properties are determined on the basis of column designations and/or table designations.

8. The method according to claim 7, wherein the similarity value characterizing the similarity between columns of different tables or the similarity between different tables is determined on the basis of the semantic table properties.

9. The method according to claim 1 wherein the pre-trained machine-learning computing modules have been pre-trained on the basis of training data that is different from the column-related metadata of the received tables and contains predetermined patterns.

10. The method according to claim 1 wherein, after calculating the at least one similarity value, the machine-learning computing modules are retrained in that the calculated similarity value is evaluated and evaluation information is generated and in that, on the basis of the evaluation information, the machine-learning computing modules and/or the generation of combination pattern indicators are adjusted.

11. The method according to claim 1 wherein, when forming combination pattern indicators, the pattern indicators are weighted differently.

12. The method according to claim 1 wherein, on the basis of the tables and the similarity relations of tables, a graphical output is generated which represents the similarity relations of the overall tables and the columns of the individual tables.

13. The method according to claim 1 wherein when the information contained in the tables changes, the column-related metadata, the pattern indicators and the combination pattern indicators resulting therefrom are redetermined and, based thereon, the similarity value characterizing the similarity between columns of different tables and/or the similarity between different tables is recalculated.

14. Non-transitory computer-readable media comprising instructions which, when the instructions are executed by a computer, cause the computer to perform the steps of the method according to claim 1.
